(19) United States
(12) Patent Application Publication
(10) Pub. No.: US 2022/0067231 A1
(43) Pub. Date: Mar. 3, 2022

(54) METHOD AND SYSTEM FOR AUTOMATICALLY CALCULATING ARTIFICIAL INTELLIGENCE-BASED DESIGN WIND SPEED

(71) Applicant: Seoul National University R&DB Foundation, Seoul (KR)

(72) Inventors: Thomas Hyun Koo KANG, Seoul (KR); Seung Yong JEONG, Daejeon (KR); Dong Hyeok LEE, Seoul (KR)

(73) Assignee: Seoul National University R&DB Foundation, Seoul (KR)

(21) Appl. No.: 17/415,734

(22) PCT Filed: Oct. 7, 2019
(86) PCT No.: PCT/KR2019/013114

§ 371 Date: Jun. 18, 2021

(30) Foreign Application Priority Data
Jan. 30, 2019 (KR) 10-2019-0012058

(51) Int. Cl. G06F 30/13; G06N 3/02; G01P 5/08

(52) U.S. Cl. CPC G06F 30/13; G01P 5/08; G06N 3/02

(57) ABSTRACT

The present invention relates to a method and system for automatically calculating an artificial intelligence (AI)-based design wind speed, which capable of economically designing a structure by quickly and accurately calculating the design wind speed at a target point through relationship learning between the design target point and a neighboring weather observation station by AI.

### TECHNICAL FIELD

The present invention relates to a method and system for automatically calculating a design wind speed based on artificial intelligence, which can economically design a structure by quickly and accurately calculating a design wind speed at a target point through learning the relation between a design target point and surrounding weather observation stations by the artificial intelligence.

### BACKGROUND ART

Influence of wind load should be considered in designing a structure, and a design wind speed is required to calculate the wind load.

Practically, the design wind speed V_{z} is calculated by applying a velocity pressure exposure coefficient K_{zr}, a topographic factor K_{zt}, and the like to the regional basic wind speed V₀ suggested in the building structure standards.

Here, the basic wind speed V₀ is an expected wind speed of a 100-year return period for the wind speed of 10-minute average at a height of 10 meter in the region of ground surface roughness C, and is classified by region as shown in FIG. 1.

In addition, the velocity pressure exposure coefficient K_{zr} is a vertical direction distribution coefficient expressing distribution of wind speed increase up to the height of beginning the atmospheric boundary layer and the reference height for longitude wind according to the altitude of the ground surface according to the exponential law, and is calculated to be different according to the ground surface roughness.

At this point, the ground surface roughness is classified into four categories according to the ground surface condition of the surrounding terrain, i.e., arrangement and height of buildings, as shown in FIG. 2.

In addition, the topographic factor K_{zt} is a factor reflecting the shapes of hills or the like around a corresponding site in a simplified calculation method.

However, the basic wind speed in each city suggested in the building structure standards is the maximum value in the surrounding terrain, and it is greatly different from the wind speed of a region where real target buildings are located, and is very conservative.

In addition, since classification of the ground surface roughness reflected in the velocity pressure exposure coefficient K_{zr} suggested in the building structure standards for calculation of a design wind speed depends on qualitative determination of an engineer, the design results may vary from engineer to engineer.

In addition, there is a problem in that the topographic factor K_{zt} cannot properly reflect the influence of a terrain having a three-dimensionally complex structure. When it is actually calculated by applying a coefficient that corrects the design wind speed suggested in the building structure standards, based on the topographic information between two weather observation stations by the recording of wind speed observed at one observation station for the two weather observation stations, a considerable error occurs compared to the observation records of the other station.

This means that there is a considerable limit in the correction factor suggested in the existing building structure standards.

Meanwhile, Vworld, which is the spatial information open platform of the Ministry of Land, Infrastructure and Transport (Korea), provides 3D topography and building maps, and this can be used as a reference in calculating classification of ground surface roughness.

However, since there is a limit in collecting a large amount of data nationwide in practice, 3D building maps are provided only for specific cities. In addition, 3D maps are provided only for artificial structures such as buildings or roads, and detailed modeling of trees in a mountainous terrain or natural terrains such as rice or farm fields is insufficient. Accordingly, it is difficult to accurately grasp actual roughness of the ground surface, i.e., ground surface roughness.

### DISCLOSURE OF INVENTION

### Technical Problem

Therefore, the present invention has been made in view of the above problems, and it is an object of the present invention to provide a method and system for automatically calculating a design wind speed based on artificial intelligence, which can calculate an optimized design wind speed at a target point through learning the relation between geographic information of target point and wind speeds from surrounding weather observation stations by the artificial intelligence.

Another object of the present invention is to provide a method and system for automatically calculating a design wind speed based on artificial intelligence, which can specifically and comprehensively reflect geographic information such as topography, distance, ground surface roughness, and altitude by learning of the artificial intelligence.

Another object of the present invention is to provide a method and system for automatically calculating a design wind speed based on artificial intelligence, which can prevent overdesign of a building structure by providing a more accurate design wind speed than the conservative design wind speed suggested in the building structure standards.

### Technical Solution

The present invention according to a preferred embodiment provides a method of automatically calculating a design wind speed based on artificial intelligence, the method comprising: (a) a data preprocessing step selecting a certain observation station as a reference observation station S, selecting a plurality of observation stations located around the reference observation station as neighboring observation stations, and collecting wind speed and wind direction data of the reference observation station and the neighboring observation stations and geographic information element data of an area between the reference observation station and the neighboring observation stations; (b) a learning step of grasping geographic information between two points by integrating the geographic information element data through learning of the artificial intelligence, and generating a wind speed impact model, i.e., a relation of the geographic information with a wind speed ratio between the observation stations; (c) an expected wind speed calculating step of selecting at least one observation station located around a target point O where a design target building is located as a basic observation station P′ₙ, and calculating an expected wild speed at the target point from the wild speed impact model based on the geographic information, which is grasped from the geographic information element data of an area between the target point and the basic observation station, and the wind speed data of the basic observation station; and (d) a design wind speed calculating step of calculating a design wind speed for a set return period from the expected wind speed data of the target point.

The present invention according to another preferable embodiment provides a method of automatically calculating a design wind speed based on artificial intelligence, in which step (a) further includes a preprocessing step of processing the collected data into effective data for supervised learning.

The present invention according to another preferable embodiment provides a method of automatically calculating a design wind speed based on artificial intelligence, in which at step (a), the preprocessing step extracts only a wind speed of a case where the observed wind direction of the neighboring observation station is toward the reference observation station as an effective wind speed of the neighboring observation station and the reference observation station, and at step (b), the wind speed impact model is generated by a ratio of the effective wind speed.

The present invention according to another preferable embodiment provides a method of automatically calculating a design wind speed based on artificial intelligence, in which at step (a), the preprocessing step corrects a time lag of the effective wind speed between two observation stations according to a distance between the reference observation station and the neighboring observation station.

The present invention according to another preferable embodiment provides a method of automatically calculating a design wind speed based on artificial intelligence, in which at step (c), the expected wind speed at the target point is calculated by multiplying the wind speed of the basic observation station by the wind speed ratio calculated by inputting the geographic information between the target point and the basic observation station into the wind speed impact model.

The present invention according to another preferable embodiment provides a method of automatically calculating a design wind speed based on artificial intelligence, in which at step (d), an annual maximum wind speed is obtained from the expected wind speed data of the target point, and the design wind speed is calculated for the set return period by performing extreme statistics analysis on the annual maximum wind speed data.

The present invention according to another preferable embodiment provides a method of automatically calculating a design wind speed based on artificial intelligence, in which at step (d), the design wind speed is calculated for each direction of the basic observation stations around the target point.

The present invention according to another preferable embodiment provides a method of automatically calculating a design wind speed based on artificial intelligence, in which at step (b), the geographic information is generated using a convolutional neural network (CNN) using the geographic information element data as an input value, and the wind speed impact model is generated by learning the geographic information together with the wind speed ratio.

The present invention according to another preferable embodiment provides a system for automatically calculating a design wind speed based on artificial intelligence, the system comprising: a data preprocessing module for selecting a certain observation station as a reference observation station S, selecting a plurality of observation stations located around the reference observation station as neighboring observation stations Pₙᵣ and collecting wind speed and wind direction data of the reference observation station and the neighboring observation stations and geographic information element data of an area between the reference observation station and the neighboring observation stations; a learning module for grasping geographic information between two points by integrating the geographic information element data through learning of the artificial intelligence, and generating a wind speed impact model, i.e., a relation of the geographic information with a wind speed ratio between the observation stations; a wind speed calculation module for selecting at least one observation station located around a target point where a design target building is located as a basic observation station, and calculating an expected wind speed at the target point from the wind speed impact model based on the geographic information, which is grasped from the geographic information element data of an area between the target point and the basic observation station, and the wind speed data of the basic observation station; and a design wind speed calculation module for calculating a design wind speed for a set return period from the expected wind speed data of the target point.

### Advantageous Effects

According to the present invention, it is possible to provide a method and system for automatically calculating a design wind speed based on artificial intelligence, which can calculate an optimized design wind speed at a target point through learning the relation between a design target point and surrounding weather observation stations by the artificial intelligence.

That is, since actual geographic information between a plurality of weather observation stations is learned and reflected using artificial intelligence, the wind speed in a target region can be predicted although the distance to the observation station is far or the topography is complex.

In addition, it is possible to respond very quickly to climate changes since records of weather observation stations updated every year can be used.

Accordingly, since the design wind speed optimized for a design target region can be calculated quickly, it is possible to design economically by preventing overdesign of a structure by calculating the design wind speed more accurately than the conservative design wind speed suggested in the building structure standards.

### BRIEF DESCRIPTION OF THE DRAWINGS

FIG. 1 is a table showing the basic design wind speed by region.

FIG. 2 is a table showing ground surface roughness.

FIG. 3 is a flowchart illustrating a method of automatically calculating a design wind speed based on artificial intelligence according to the present invention.

FIG. 4 is a configuration view showing the overall concept of a method of automatically calculating a design wind speed based on artificial intelligence according to the present invention.

FIG. 5 is a view showing a state of designating a reference observation station and neighboring observation stations.

FIG. 6 is a view showing the relation of wind speed and geographic information between a reference observation station and neighboring observation stations.

FIG. 7 is a view showing a state of designating a target point and basic observation stations.

FIG. 8 is a diagram showing a design wind speed.

FIG. 9 is a block diagram showing the configuration of a system for automatically calculating a design wind speed based on artificial intelligence according to the present invention.

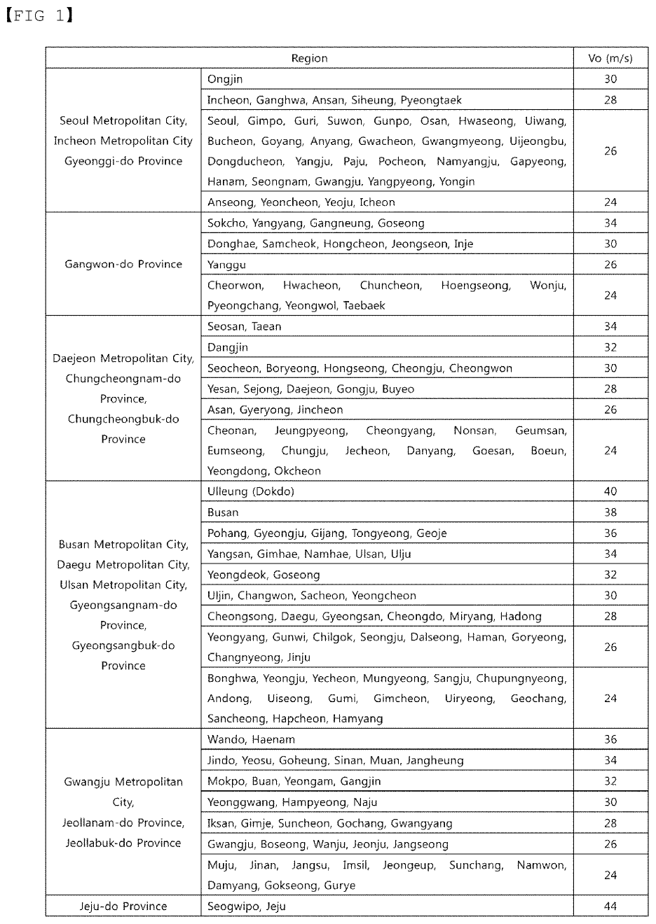

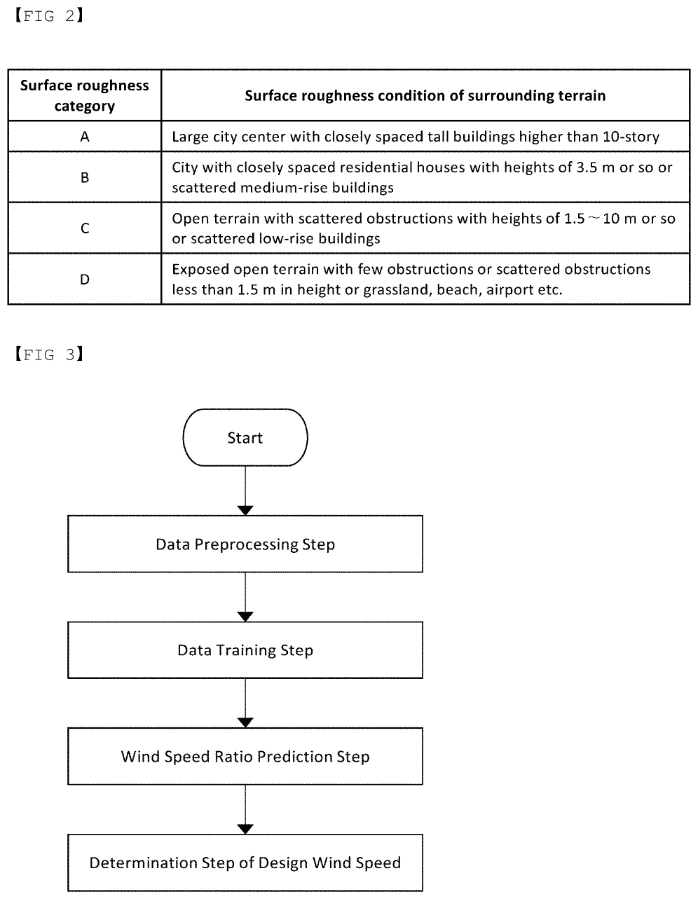

### BEST MODE FOR CARRYING OUT THE INVENTION

To accomplish the objects described above, a method of automatically calculating a design wind speed based on artificial intelligence according to the present invention provides comprises: (a) a data preprocessing step of selecting a certain observation station as a reference observation station S, selecting a plurality of observation stations located around the reference observation station as neighboring observation stations, and collecting wind speed and wind direction data of the reference observation station and the neighboring observation stations and geographic information element data of an area between the reference observation station and the neighboring observation stations; (b) a learning step of grasping geographic information between two points by integrating the geographic information element data through learning of the artificial intelligence, and generating a wind speed impact model, i.e., a relation of the geographic information with a wind speed ratio between the observation stations; (c) an expected wind speed calculating step of selecting at least one observation station located around a target point O where a design target building is located as a basic observation station P′ₙ, and calculating an expected wind speed at the target point from the wind speed impact model based on the geographic information, which is grasped from the geographic information element data of an area between the target point and the basic observation station, and the wind speed data of the basic observation station; and (d) a design wind speed calculating step of calculating a design wind speed for a set return period from the expected wind speed data of the target point.

Hereinafter, the present invention will be described in detail according to the accompanying drawings and preferred embodiments.

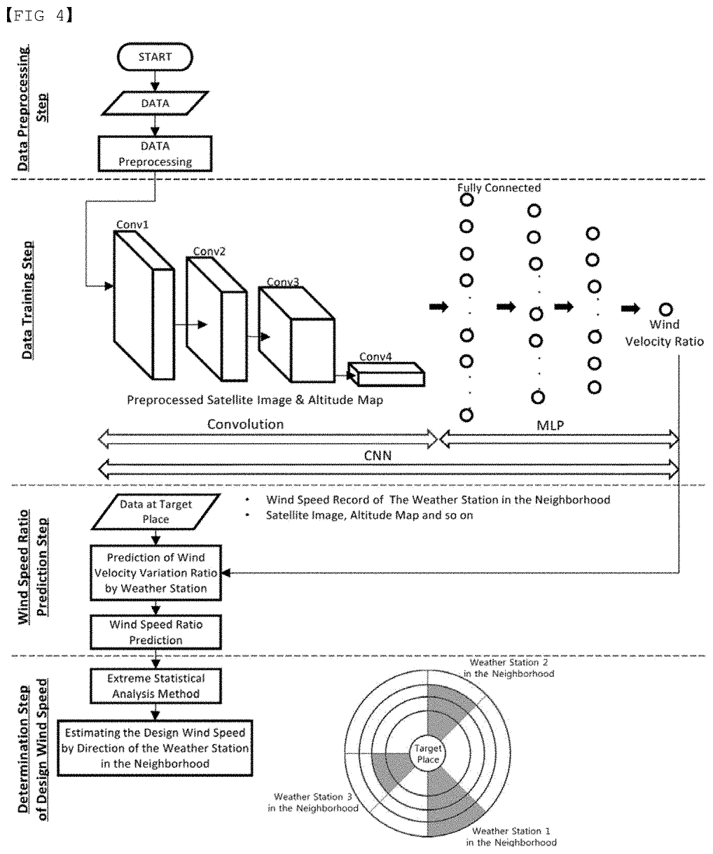

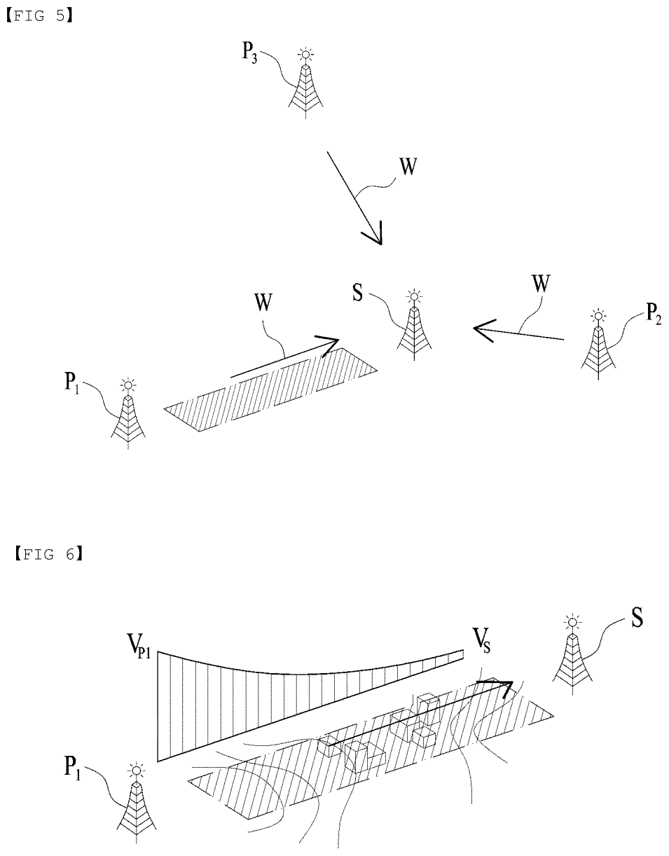

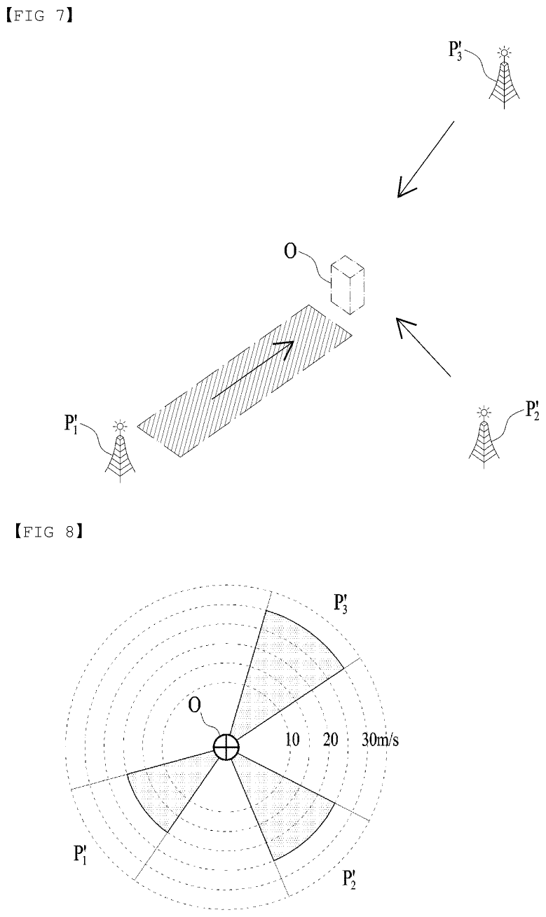

FIG. 3 is a flowchart illustrating a method of automatically calculating a design wind speed based on artificial intelligence according to the present invention, and FIG. 4 is a configuration view showing the overall concept of a method of automatically calculating a design wind speed based on artificial intelligence according to the present invention. FIG. 5 is a view showing a state of designating a reference observation station and neighboring observation stations, FIG. 6 is a view showing the relation of wind speed and geographic information between a reference observation station and neighboring observation stations, and FIG. 7 is a view showing a state of designating a target point and basic observation stations.

As shown in FIG. 3, FIG. 4 and the like, a method of automatically calculating a design wind speed based on artificial intelligence according to the present invention includes: (a) a data preprocessing step of selecting a certain observation station as a reference observation station S, selecting a plurality of observation stations located around the reference observation station S as neighboring observation stations Pₙ, and collecting wind speed and wind direction data of the reference observation station S and the neighboring observation stations Pₙ and geographic information element data of an area between the reference observation station S and the neighboring observation stations Pₙ; (b) a learning step of grasping geographic information between two points by integrating the geographic information element data through learning of the artificial intelligence, and generating a wind speed impact model, i.e., a relation of the geographic information with a wind speed ratio between the observation stations; (c) an expected wind speed calculating step of selecting at least one observation station located around a target point O where a design target building is located as a basic observation station P′ₙ, and calculating an expected wind speed at the target point O from the wind speed impact model based on the geographic information, which is grasped from the geographic information element data of an area between the target point O and the basic observation station P′ₙ, and the wind speed data of the basic observation station P′ₙ; and (d) a design wind speed calculating step of calculating a design wind speed for set return period from the expected wind speed data of the target point O.

The present invention is to provide a method and system for automatically calculating a design wind speed based on artificial intelligence, which can quickly, accurately and automatically calculate a design wind speed at a target point O through learning the relation between a design target point and surrounding weather observation stations by the artificial intelligence.

According to the present invention, artificial intelligence may learn the correlation of wind speed and wind direction of several observation stations with geographic information between the observation stations, and by using this, a design wind speed of a target region may be automatically calculated through observation results of neighboring observation stations Pₙ around a specific target region and satellite image information.

The method of automatically calculating a design wind speed based on artificial intelligence according to the present invention includes (a) a data preprocessing step, (b) a data learning step, (c) an expected wind speed calculating step, and (d) a design wind speed calculating step.

At step (a), basic data for learning how the geographic information between two points affects the wind speed change is collected.

To this end, wind speed and wind direction data of the reference observation station S and a neighboring observation station Pₙ paired with the reference observation station S are collected in pairs.

In addition, geographic information element data affecting the geographic information are collected to grasp the geographic information between two points.

The geographic information element data includes the latitude and longitude, satellite images, altitude maps, facility height data, vegetation data (vegetation area, height, density, etc.) and the like of an observation station, and the distance between the two points may be grasped through the satellite images and altitude maps.

In Korea, there are 96 automated synoptic observing systems and 494 automated weather systems nationwide. Here, each weather observation station may function as a reference observation station S and also as a neighboring observation station Pₙ.

Therefore, as shown in FIG. 5, many combinations of the reference observation station S and a neighboring observation station Pₙ are generated.

At step (b), artificial intelligence analyzes and integrates geographic information element data and digitizes the data, and learns the relation with the wind speed ratio as a label, which is a predetermined explicit answer of a function, to create a wind speed impact model, i.e., a kind of function.

At this point, the digitized geographic information is calculated by analyzing and integrating the geographic information element data, and the artificial intelligence learns the relation between the calculated geographic information and the wind speed ratio (FIG. 6).

That is, the geographic information element data becomes training data, which is an input value, and the wind speed ratio is a value calculated from the observed wind speed of the two points, which is a result value. In addition, through the learning, the artificial intelligence creates a wind speed impact model, which is a relation of the geographic information with respect to the wind speed ratio (Vₛ/V_{P1}) of two points, which is a label.

In the existing building structure standards, a design wind speed V_{z} is calculated from the basic wind speed V₀ based on the velocity pressure exposure coefficient K_{zr} and the topographic factor K_{zt} of the wind speed reflecting the ground surface roughness. On the contrary, the present invention does not separately distinguish the velocity pressure exposure coefficient K_{zr} and the topographic factor and K_{zt}, and comprehensively reflects the mixed influence through actual specific geographic information of a corresponding region by learning of the artificial intelligence.

That is, in the present invention, the geographic information is a concept including a composite effect of topography, distance, ground surface roughness, altitude and the like.

Although the topography of a target region may be grasped from satellite images and altitude maps, and the ground surface roughness may be grasped through satellite images, facility height data, vegetation data, and the like, basically, since the present invention does not calculate an exact relation of each of these influences, it does not need to treat them separately.

However, it is possible to add a step of separately learning only the ground surface roughness as needed to convert the ground surface roughness into a result value and predict a design wind speed from the result value.

At step (c), an expected wind speed is calculated for an arbitrary design target point without having an observation station by using the wind speed impact model generated by learning of the artificial intelligence at step (b) described above.

At this point, the expected wind speed at the target point O is calculated using the wind speed impact model based on the geographic information between the target point O and the basic observation station P′ₙ located around the target point O and wind speed data of the basic observation station P′ₙ.

One or more basic observation stations P′ₙ may be selected depending on the structure to be designed at the target point O and the purpose of using the wind speed data.

It is preferable to designate a location close to the target point O as the basic observation station P′ₙ to enhance accuracy of the expected wind speed.

In addition, when a plurality of basic observation stations P′ₙ is needed, it is preferable to designate the basic observation stations P′ₙ to be evenly distributed in all directions as much as possible as shown in FIG. 7.

Particularly, when a design wind speed is calculated for a wind tunnel experiment, the basic observation station P′ₙ may be selected to correspond to an arbitrary direction required for the wind tunnel experiment.

At step (d), a design wind speed for a set return period is calculated from the expected wind speed data of the target point O.

The expected wind speed at the target point O calculated at step (c) is a value that changes from moment to moment in connection with the observation data of the basic observation station P′ₙ, and the expected wind speed is a data that cannot be directly used as the design wind speed.

Therefore, the expected wind speed is statistically analyzed to be reflected in the structure design, and the maximum wind speed is calculated for the set return period.

Although the return period may be set to 100 years, which is basically stipulated in the building structure standards, it may be changed according to the characteristic, usage and the like of the structure.

The maximum wind speed may be calculated through extreme statistics analysis on the return period.

Therefore, at step (d), an annual maximum wind speed may be obtained from the expected wind speed at the target point O, and a design wind speed for the return period may be calculated using the extreme statistics analysis method.

Although the basic wind speed stipulated in the building structure standards is reflected by calculating records up to a specific year, in the present invention, since records of weather observation stations updated every year may be used, it is possible to very quickly respond to climate changes.

In addition, although it is difficult to consider various geographic variables since the building structure standards classify the topography and the ground surface roughness into several categories to apply, in the present invention, since actual geographic information between a plurality of weather observation stations is learned using artificial intelligence, the wind speed in a target region may be predicted although the distance to the observation station is far or the topography is complex.

Accordingly, since the design wind speed optimized for a design target region can be calculated quickly, overdesign of a building structure can be prevented by calculating the design wind speed more accurately than the conservative design wind speed suggested in the building structure standards.

Step (a) may further include a preprocessing step of processing the collected data into effective data for supervised learning.

In the present invention, the wind speed impact model is generated by training the relation with distribution of buildings and vegetation using a value related to the observed wind speed as a label, which is an explicit answer.

To this end, the wind speed impact model may be generated by supervised learning, which is a learning method that infers a result while a label for data is given.

Accordingly, as the collected data is preprocessed by a preprocessing module to be suitable for supervised learning, the effective data may be extracted or generated.

It may be configured such that at step (a), the preprocessing step extracts only the wind speed of a case where the observed wind direction of the neighboring observation station Pₙ is toward the reference observation station S as an effective wind speed of the neighboring observation station Pₙ and the reference observation station S, and at step (b), the wind speed impact model is generated by the ratio of the effective wind speed.

In order to confirm the influence of the topography and the ground surface roughness between a specific neighboring observation station Pₙ and the reference observation station S on the wind speed change, the wind speed should be measured for the same wind blowing from the specific neighboring observation station Pₙ toward the reference observation station S.

That is, it should be possible to select only the wind speed data of a case where the specific neighboring observation station Pₙ and the reference observation station S are located on the isogon.

To this end, the preprocessing module may extract only the wind speed data measured at the specific neighboring observation station Pₙ and the reference observation station S when the wind direction is toward the reference observation station S as an effective wind speed in association with the wind direction observed at the neighboring observation station Pₙ.

Accordingly, at step (b), the artificial intelligence may generate the wind speed impact model by learning the relation between the geographic information of a region corresponding to the effective wind speed and the effective wind speed ratio of two points, which is a label.

In addition, at step (d), only the wind speed of a case where the wind direction of the wind observed at the basic observation station P′ₙ is toward the reference observation station S is extracted as the effective wind speed, and this can be used as a data for calculating the expected wind speed of the reference observation station S.

It may be configured such that at step (a), the preprocessing step corrects the time lag of the effective wind speed between two observation stations according to the distance between the reference observation station S and the neighboring observation station Pₙ.

Since the reference observation station S and the neighboring observation station Pₙ may be spaced apart from each other by a considerable distance, it may take a predetermined time for the wind blowing from the neighboring observation station Pₙ to reach the reference observation station S.

Therefore, in order to grasp the influence of the ground surface roughness between the reference observation station S and the neighboring observation station Pₙ on the wind speed, the time taken for the wind to reach should be reflected.

Accordingly, it needs to correct the time lag to synchronize two correlated data, each having a different observation time of the observation data between the two stations.

The time correction like this may be performed in a cross-correlation method.

At step (c), the expected wind speed at the target point O may be calculated by multiplying the wind speed of the basic observation station P′ₙ by the wind speed ratio calculated by inputting the geographic information between the target point O and the basic observation station P′ₙ into the wind speed impact model.

The geographic information between the target point O and the basic observation station P′ₙ is a data digitized by analyzing the geographic information element data between the two points using artificial intelligence.

Since the relation of the geographic information with the wind speed ratio has already been established in the wind speed impact model generated at step (b), when geographic information element data such as a satellite map, an altitude map, a facility height, and the like between the target point O and the basic observation station P′ₙ is input, the wind speed ratio is automatically calculated as a result value (label) corresponding to the geographic information of the two points.

When the wind speed of the basic observation station P′ₙ is multiplied by the calculated wind speed ratio, an expected wind speed at the target point O is calculated.

The wind speed and wind direction data of the basic observation station P′ₙ may be a real-time observation value or a stored value observed by year and stored in a DB.

It may be configured such that at step (d), an annual maximum wind speed is obtained from the expected wind speed data of the target point O, and a design wind speed is calculated for a set return period by performing extreme statistics analysis on the annual maximum wind speed data.

The annual maximum wind speed may be calculated by a moving average wind speed calculated using time history (every 10 minutes) of the expected wind speed calculated by label correction.

The design wind speed for a desired return period (e.g., 100 years) may be calculated from the wind speed data using an extreme statistics analysis method such as Weibull distribution or Gumbel distribution.

FIG. 8 is a diagram showing a design wind speed.

As shown in FIG. 8, at step (d), the design wind speed may be calculated for each direction of the basic observation stations P′ₙ around the target point O.

Although the actual wind load applied to a building acts differently according to the layout and direction of the building, the wind load design based on the existing building structure standards does not reflect the difference in the direction and applies only a single value.

In addition, since the same design wind speed is applied to each direction in the wind tunnel experiment conducted to examine the influence of the actual wind load in advance, it is difficult to accurately reflect actual field conditions.

Alternatively, in the present invention, the design wind speed at the target point O may be calculated according to the geographic information between the target point O and the basic observation station P′ₙ. Therefore, the design wind speed may be calculated for each direction by designating a basic observation station P′ₙ in each desired direction.

Therefore, more precise design is possible, and it is easy to grasp the influence of wind.

Meanwhile, it may be configured such that at step (b), the geographic information is generated using a convolutional neural network (CNN) using the geographic information element data as an input value, and a wind speed impact model is generated by learning the geographic information together with the wind speed ratio.

At step (b), a convolutional neural network (CNN) may be used as a deep learning technique for analyzing the geographic information element data including satellite images, altitude maps, and the like.

The convolutional neural network (CNN) is one of deep learning algorithms, and it is used to recognize an image by extracting features from the image and digitizing the features.

The object of the present invention is not image recognition itself, but digitization of data related to geographic information. Therefore, a value of a fully connected neural network extracted from a flatten layer during the process of CNN is used.

That is, when an image repeatedly passes through convolution layers (Conv1, Conv2, . . . ) in the CNN, only major features are extracted, and the extracted major features are transferred to the fully connected layer to be used for learning.

Here, although the convolutional layers mainly deal with two-dimensional data, since the two-dimensional data should be converted into one-dimensional data to be transferred to the fully connected layer, the flatten layer is used at this point.

Thereafter, wind speed impact model may be generated by learning the relation of data values of the satellite images and the altitude map obtained through the convolution, and latitudes and longitudes with the wind speed ratio through a multilayer perceptron (MLP) algorithm.

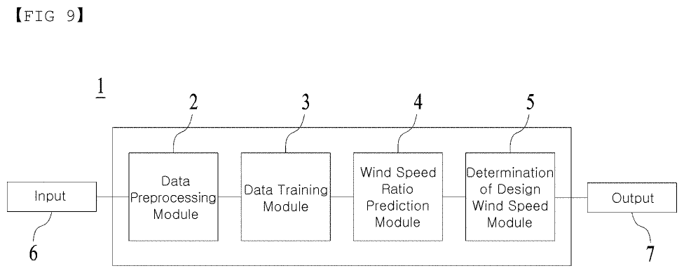

FIG. 9 is a block diagram showing the configuration of a system for automatically calculating a design wind speed based on artificial intelligence according to the present invention.

As shown in FIG. 9, the system for automatically calculating a design wind speed based on artificial intelligence according to the present invention may be configured to include: a data preprocessing module 2 for selecting a certain observation station as a reference observation station S, selecting a plurality of observation stations located around the reference observation station S as neighboring observation stations Pₙ, and collecting wind speed and wind direction data of the reference observation station S and the neighboring observation stations Pₙ and geographic information element data of an area between the reference observation station S and the neighboring observation stations Pₙ; a learning module 3 for grasping geographic information between two points by integrating the geographic information element data through learning of the artificial intelligence, and generating a wind speed impact model, i.e., a relation of the geographic information with a wind speed ratio between the observation stations; a wind speed calculation module 4 for selecting at least one observation station located around a target point O where a design target building is located as a basic observation station P′ₙ, and calculating an expected wind speed at the target point O from the wind speed impact model based on the geographic information, which is grasped from the geographic information element data of an area between the target point O and the basic observation station P′ₙ, and the wind speed data of the basic observation station P′ₙ; and a design wind speed calculation module 5 for calculating a design wind speed for a set return period from the expected wind speed data of the target point O.

That is, the system 1 for automatically calculating a design wind speed based on artificial intelligence according to the present invention includes the data preprocessing module 2, the learning module 3, the wind speed calculation module 4, and the design wind speed calculation module 5.

The data preprocessing module 2, the learning module 3, the wind speed calculation module 4, and the design wind speed calculation module 5 may embody step (a), step (b), step (c), and step (d) of the method of automatically calculating a design wind speed based on artificial intelligence according to the present invention, respectively, and the components and functions thereof are as described above in the method of automatically calculating a design wind speed based on artificial intelligence.

### INDUSTRIAL APPLICABILITY

Since the method and system for automatically calculating a design wind speed based on artificial intelligence according to the present invention may calculate an optimized design wind speed at a target point through learning the relation between a design target point and surrounding weather observation stations by the artificial intelligence, the present invention is applicable to industry in that the wind speed in a target region can be predicted although the distance to the station is far or the topography is complex, and thus a structure can be economically designed.

1. A method of automatically calculating a design wind speed based on artificial intelligence, the method comprising:
(a) a data preprocessing step of selecting a certain observation station as a reference observation station S, selecting a plurality of observation stations located around the reference observation station S as neighboring observation stations Pₙ, and collecting wind speed and wind direction data of the reference observation station S and the neighboring observation stations Pₙ and geographic information element data of an area between the reference observation station S and the neighboring observation stations Pₙ;
(b) a learning step of grasping geographic information between two points by integrating the geographic information element data through learning the artificial intelligence, and generating a wind speed impact model, i.e., a relation of the geographic information with a wind speed ratio between the observation stations;
(c) an expected wind speed calculating step of selecting at least one observation station located around a target point O where a design target building is located as a basic observation station P′ₙ, and calculating an expected wind speed at the target point O from the wind speed impact model based on the geographic information, which is grasped from the geographic information element data of an area between the target point O and the basic observation station P′ₙ, and the wind speed data of the basic observation station P′ₙ; and
(d) a design wind speed calculating step calculating a design wind speed for a set return period from the expected wind speed data of the target point O.

2. The method according to claim 1, wherein step (a) further includes a preprocessing step of processing the collected data into effective data for supervised learning.

3. The method according to claim 2, wherein at step (a), the preprocessing step extracts only a wind speed of a case where the observed wind direction of the neighboring observation station Pₙ is toward the reference observation station S as an effective wind speed of the neighboring observation station Pₙ and the reference observation station S, and at step (b), the wind speed impact model is generated by a ratio of the effective wind speed.

4. The method according to claim 3, wherein at step (a), the preprocessing step corrects a time lag of the effective wind speed between two observation stations according to a distance between the reference observation station S and the neighboring observation station Pₙ.

5. The method according to claim 1, wherein at step (c), the expected wind speed at the target point O is calculated by multiplying the wind speed of the basic observation station P^{′}ₙ by the wind speed ratio calculated by inputting the geographic information between the target point O and the basic observation station P′ₙ into the wind speed impact model.

6. The method according to claim 1, wherein at step (d), an annual maximum wind speed is obtained from the expected wind speed data of the target point O, and the design wind speed is calculated for the set return period by performing extreme statistics analysis on the annual maximum wind speed data.

7. The method according to claim 1, wherein at step (d), the design wind speed is calculated for each direction of the basic observation stations P′ₙ around the target point O.

8. The method according to claim 1, wherein at step (b), the geographic information is generated using a convolutional neural network (CNN) using the geographic information element data as an input value, and the wind speed impact model is generated by learning the geographic information together with the wind speed ratio.

9. A system for automatically calculating a design wind speed based on artificial intelligence, the system comprising:
a data preprocessing module 2 for selecting a certain observation station as a reference observation station S, selecting a plurality of observation stations located around the reference observation station S as neighboring observation stations Pₙ, and collecting wind speed and wind direction data of the reference observation station S and the neighboring observation stations Pₙ and geographic information element data of an area between the reference observation station S and the neighboring observation stations Pₙ;
a learning module 3 for grasping geographic information between two points by integrating the geographic information element data through learning of the artificial intelligence, and generating a wind speed impact model, i.e., a relation of the geographic information with a wind speed ratio between the observation stations;
a wind speed calculation module 4 for selecting at least one observation station located around a target point O where a design target building is located as a basic observation station P′ₙ, and calculating an expected wind speed at the target point O from the wind speed impact model based on the geographic information, which is grasped from the geographic information element data of an area between the target point O and the basic observation station P′ₙ, and the wind speed data of the basic observation station P′ₙ; and
a design wind speed calculation module 5 for calculating a design wind speed for a set return period from the expected wind speed data of the target point O.
